(19) United States
(12) Patent Application Publication
(10) Pub. No.: US 2019/0369425 A1
(43) Pub. Date: Dec. 5, 2019

(54) OPTICAL DEVICE AND METHOD FOR MANUFACTURING OPTICAL DEVICE

(71) Applicant: PANASONIC INTELLECTUAL PROPERTY MANAGEMENT CO., LTD., Osaka (JP)

(72) Inventors: Masuyuki OTA, Ishikawa (JP); Yuko SUZUKA, Kyoto (JP)

(73) Assignee: PANASONIC INTELLECTUAL PROPERTY MANAGEMENT CO., LTD., Osaka (JP)

(21) Appl. No.: 16/485,545

(22) PCT Filed: Oct. 17, 2017
(86) PCT No.: PCT/JP2017/037440

§ 371 Date: Aug. 13, 2019

(30) Foreign Application Priority Data
Feb. 16, 2017 (JP) 2017-027181

(51) Int. Cl. G02F 1/1337; G02F 1/1343

(52) U.S. Cl. CPC G02F 1/1337; G02F 2001/133776; G02F 1/13439

(57) ABSTRACT

An optical device includes: a pair of base members (a first base member and a second base member) having a light transmittance; a pair of electrodes (a first electrode and a second electrode) having a light transmittance and located between the pair of base members; a first free-surface film including an inorganic material and disposed above one of the pair of electrodes; a second free-surface film including an inorganic material and disposed above another of the pair of electrodes; and a liquid crystal layer located between the first free-surface film and the second free-surface film (32).

### TECHNICAL HELD

The present invention relates to an optical device and a method for manufacturing the optical device.

### BACKGROUND ART

There is a proposed optical device capable of controlling the distribution of light incident thereon. Such an optical device is used in a window of a building, a car, or any other object. For example, the optical device installed in a window of a building can change the traveling direction of externally incident outside light, such as sunlight, to introduce the outside light toward the ceiling of a room.

As an optical device of this type, there is a known liquid crystal optical device including a pair of transparent substrates, a pair of transparent electrodes disposed inside the pair of transparent substrates, and a liquid crystal layer located between the pair of transparent electrodes (PTL 1, for example). The optical device changes the orientation of the liquid crystal molecules in the liquid crystal layer in accordance with voltage applied to the pair of transparent electrodes to change the traveling direction of light incident on the optical device.

### CITATION LIST

### Patent Literature

PTL 1: Japanese Unexamined Patent Application Publication No. 2012-173534

### SUMMARY OF THE INVENTION

### Technical Problems

In an optical device including a liquid crystal layer, an alignment film is used to orient the liquid crystal molecules in the liquid crystal layer in a fixed axis. For example, in the liquid crystal optical device described in PTL 1, alignment films are formed on the interfaces on opposite sides of the liquid crystal layer. Specifically, an alignment film is formed on the surface of an irregular layer formed on one of the transparent substrates, and another alignment film is formed on the surface of the transparent electrode formed on the other transparent substrate.

An optical device using an alignment film, however, has problems of low reliability and poor productivity.

Further, in an active optical device in which a pair of electrodes drive a liquid crystal layer, power saving is desired by using low voltage driving.

The present invention has been made to solve the problems, and an object of the present invention is to provide an optical device that excels in productivity and reliability and allows power saving and further provide a method for manufacturing the optical device.

### Solutions to Problems

In order to achieve the above-described object, in accordance with an aspect of the present invention, there is provided an optical device, including: a pair of base members having a light transmittance; a pair of electrodes having a light transmittance and located between the pair of base embers; a first free-surface film comprising an inorganic material and disposed above one of the pair of electrodes; a second free-surface film comprising an inorganic material and disposed above another of the pair of electrodes; and a liquid crystal layer located between the first free-surface film and the second free-surface film.

In accordance with another aspect of the present invention, there is provided a method for manufacturing an optical device, the method including: forming a first electrode having a light transmittance on a first base member having a light transmittance and forming a first free-surface film comprising an inorganic material on the first electrode, thereby producing a first laminate substrate; forming a second electrode having a light transmittance on a second base member having a light transmittance and forming a second free-surface film comprising an inorganic material on the first electrode, thereby producing a second laminate substrate; and disposing the first laminate substrate and the second laminate substrate in such a way that the first free-surface film and the second free-surface film face each other, and filling a gap between the first laminate substrate and the second laminate substrate with a liquid crystal layer, wherein in the producing of the first laminate substrate, at least one of the first free-surface film and the second free-surface film is deposited by using evaporation, sputtering, or application.

### Advantageous Effect of Invention

According to the present invention, an optical device that excels in productivity and reliability and allows power saving can be embodied.

### BRIEF DESCRIPTION OF DRAWINGS

FIG. 1 is a cross-sectional view of an optical device according to Embodiment 1.

FIG. 2 is an enlarged cross-s al view of the optical device according to Embodiment 1.

FIG. 3A illustrates a first optical effect of the optical device according to Embodiment 1.

FIG. 3B illustrates a second optical effect of the optical device according to Embodiment 1.

FIG. 4 is an enlarged cross-sectional view of an optical device according to Comparative Example,

FIG. 5 is an enlarged cross-sectional view of an optical device according to Embodiment 2,

FIG. 6 shows an arrangement of liquid crystal molecules in a case where a voltage is applied to the optical device according to Embodiment 2,

FIG. 7 is an enlarged cross-sectional view of an optical device according to Variation 1.

FIG. 8 is an enlarged cross-sectional view of an optical device according to Variation 2.

### DESCRIPTION OF EXEMPLARY EMBODIMENTS

Hereinafter, embodiments of the present invention are described. It should be noted that all the embodiments described below are preferable and specific examples of the present invention. Numerical values, shapes, materials, constituent elements, arrangement positions and the connection configuration of the constituent elements, and the like described in the following embodiments are merely examples, and are not intended to limit the present invention. The present invention is characterized by the appended claims. Therefore, among the constituent elements in the following embodiments, constituent elements that are not described in independent claims that show the most generic concept of the present invention are described as elements constituting more desirable configurations.

Each figure in the Drawings is a schematic diagram and is not necessarily an exact diagram. Therefore, the reduced scale and the like of each figure are not necessarily correct. In each figure, substantially identical constituent elements are assigned with a same reference sign, and explanation of such substantially identical constituent elements is sometimes not repeated or simplified.

In the present specification and drawings, X, Y, and Z axes represent the three axes of a three-dimensional orthogonal coordinate system, with the Z axis representing the vertical axis and an axis perpendicular to the Z axis (axis parallel to XY plane) representing the horizontal axis in the embodiment. The X and Y axes are axes perpendicular to each other and both perpendicular to the Z axis. The positive direction of the Z axis represents the vertically downward direction. Further, in the present specification, the “thickness-wise along” means along the thickness of an optical device and is an axis perpendicular to the principal surfaces of first base member 11 and second base member 12 (Y axis in present embodiment), and a “plan view” means a view viewed along the axis perpendicular to the principal surfaces of first base member 11 and second base member 12.

### Embodiment 1

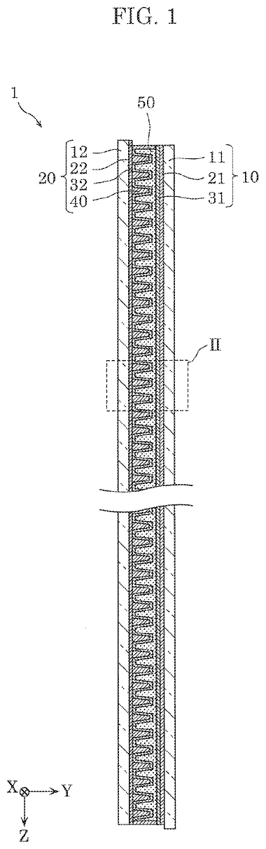

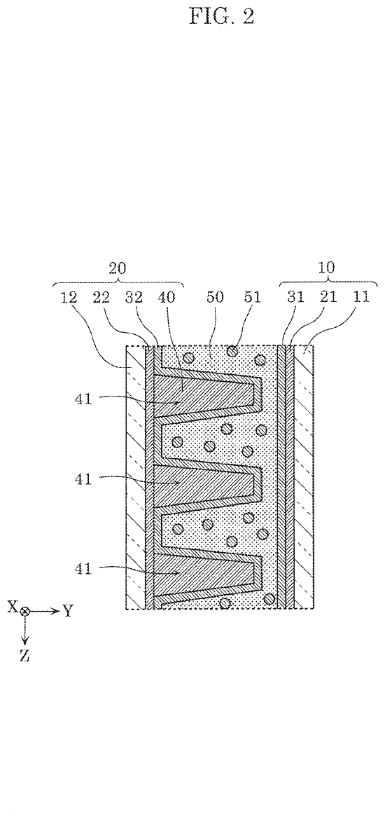

The configuration of optical device 1 according to Embodiment 1 will first be described with reference to FIGS. 1 and 2. FIG. 1 is a cross-sectional view of optical device 1 according to Embodiment 1. FIG. 2 is an enlarged cross-sectional view of optical device 1 and shows enlarged area II surrounded by the broken line in FIG. 1.

Optical device 1 is a light control apparatus that controls light incident on optical device 1. Specifically, optical device 1 is a light distribution control device capable of changing (that is, distributing) the traveling direction of the light incident on optical device 1 and outputting the distributed light.

Optical device 1 includes first base member 11 and second base member 12, which form a pair of base members, first electrode 21 and second electrode 22, which form a pair of electrodes, first free-surface film 31, second free-surface film 32, irregular layer 40, and liquid crystal layer 50, as shown in FIGS. 1 and 2.

Optical device 1 has a configuration in which first electrode 21, first free-surface film 31, liquid crystal layer 50, second free-surface film 32, irregular layer 40, and second electrode 22 are located in this order between first base member 11 and second base member 12 along the thickness of optical device 1.

In optical device 1, first base member 11, first electrode 21, and first free-surface film 31 form first laminate substrate 10, and second base member 12, second electrode 22, second free-surface film 32, and irregular layer 40 form second laminate substrate 20. First laminate substrate 10 and second laminate substrate 20 are located with a gap therebetween, and the gap is filled with liquid crystal layer 50.

Thus configured optical device 1 is an active light control apparatus that drives liquid crystal layer 50 via the pair of electrodes (first electrode 21 and second electrode 22).

The components of optical device 1 will be described below in detail with reference to FIGS. 1 and 2.

### [First Base Member, Second Base Member]

First base member 11 and second base member 12 shown in FIGS. 1 and 2 are each a light-transmitting substrate having a light transmittance. First base member 11 and second base member 12 can each, for example, be a resin substrate made of a resin material or a glass substrate made of a glass material.

Examples of the material of the resin substrate may include polyethylene terephthalate (PET), polyethylene naphthalate (PEN), polycarbonate (PC), acryl, and epoxy. Examples of the material of the glass substrate may include soda glass, non-alkali glass, and high-refractive-index glass. An advantage of the resin substrate resides in a small amount of dispersal of a broken resin substrate. On the other hand, an advantage of the glass substrate resides in high optical transmittance and low water permeability.

First base member 11 and second base member 12 may be made of the same material or different materials and preferably made of the same material. First base member 11 and second base member 12 are not each limited to a rigid substrate and may each be a flexible substrate or a film substrate. In the present embodiment, first base member 11 and second base member 12 each are made of a transparent resin substrate made of PET (PET substrate).

First base member 11 and second base member 12 are so located as to face each other. First base member 11 is a counter substrate that faces the second base member, at which irregular layer 40 is formed. First base member 11 and second base member 12 can be bonded to each other, for example, via a sealing resin, such as an adhesive, formed in the form of a frame along an outer circumferential end portion of each of first base member 11 and second base member 12, but not necessarily. For example, first base member 11 and second base member 12 may be bonded to each other with no sealing resin, for example, by welding first base member 11 and second base member 12 to each other in a laser welding process.

First base member 11 and second base member 12 each have a thickness ranging, for example, from 5 μm to 3 mm, but not necessarily. In the present embodiment, first base member 11 and second base member 12 each have a thickness of 50 μm.

First base member 11 and second base member 12 each have, for example, a square or oblong shape in the plan view, but not necessarily, and may each have a circular shape or a polygonal shape other than a quadrangular shape. That is, an arbitrary shape can be employed as the shape of each of first base member 11 and second base member 12.

### [First Electrode, Second Electrode]

First electrode 21 and second electrode 22 are paired with each other in an electrical sense and are configured to be capable of imparting an electric field to liquid crystal layer 50 as shown in FIGS. 1 and 2. First electrode 21 and second electrode 22 are paired with each other not only in an electrical sense but in a positional sense and so located as to face each other.

In the present embodiment, first electrode 21 and second electrode 22 are so located between first base member 11 and second base member 12, which form a pair of base members, as to sandwich at least irregular layer 40 and liquid crystal layer 50.

Specifically, first electrode 21 is located between first base member 11 and first free-surface film 31, and second electrode 22 is located between second base member 12 and the combination of irregular layer 40 and second free-surface film 32. More specifically, first electrode 21 is formed on a principal surface of first base member 11 that is the principal surface facing second base member 12, and second electrode 22 is formed on a surface of second base member 12 that is the surface facing first base member 11.

First electrode 21 and second electrode 22 each have a thickness ranging, for example, from 5 nm to 2 μm, but not necessarily. In the present embodiment, first electrode 21 and second electrode 22 each have a thickness of 100 nm.

First electrode 21 and second electrode 22 each have, for example, a square or oblong shape in the plan view, as do first base member 11 and second base member 12, but not necessarily. In the present embodiment, first electrode 21 and second electrode 22 are each a simple covering electrode having a rectangular shape in the plan view and formed substantially across the entire surface of the respective substrates.

First electrode 21 and second electrode 22 are each a light-transmitting electrode and transmit light incident thereon. First electrode 21 and second electrode 22 are each a transparent electrode formed, for example, of a transparent, electrically conductive layer. Examples of the material of the transparent, electrically conductive layer may include a transparent metal oxide, such as no (indium tin oxide) and IZO (indium zinc oxide), an electrical-conductor-containing resin made of a resin containing conductors, such as silver nano-wires and electrically conductive particles, and a metal thin film, such as a silver thin film. First electrode 21 and second electrode 22 may each have a single-layer structure made of any one of the materials described above or a laminate structure made of some of the materials described above (laminate structure made of transparent metal oxide and metal thin film, for example).

First electrode 21 and second electrode 22 are configured to be electrically connectable to an external power source. For example, first electrode 21 and second electrode 22 may each be drawn to a point outside the sealing resin that encapsulates liquid crystal layer 50, and the drawn portion may form an electrode terminal to be connected to the external power source.

### [First Free-Surface Film, Second Free-Surface Film]

First free-surface film 31 is disposed at first base member 11. In the present embodiment, first free-surface film 31 is disposed on first electrode 21. Specifically, first free-surface film 31 covers a surface of first electrode 21 and is in contact with liquid crystal layer 50. That is, first free-surface film 31 is present between first electrode 21 and liquid crystal layer 50.

Second free-surface film 32 is disposed at second base member 12. In the present embodiment, second free-surface film. 32 is so disposed on second electrode 22 as to cover an irregular surface of irregular layer 40. Specifically, second free-surface film 32 covers the irregular surface of irregular layer 40, also covers a surface of second electrode 22 that is the surface on which no irregular layer 40 is formed, and is in contact with liquid crystal layer 50. That is, second free-surface film 32 is present between irregular layer 40 and liquid crystal layer 50 and between second electrode 22 exposed from irregular layer 40 and liquid crystal layer 50.

First free-surface film 31 and second free-surface film 32 are each a film having a surface that serves as a free surface for liquid crystal molecules 51 in liquid crystal layer 50. The free surface used herein refers to a state in which the free surface hardly interacts with liquid crystal molecules 51 at an interface of liquid crystal layer 50 that is the interface with which liquid crystal molecules 51 are in contact so that anchoring force is extremely small. In the present embodiment, first free-surface film 31 and second free-surface film 32 are in contact with liquid crystal layer 50. Liquid crystal molecules 51 present in a portion of liquid crystal layer 50 that is the portion in the vicinity of the interfaces between liquid crystal layer 50 and first free-surface film 31/second free-surface film 32 hardly interacts with first free-surface film 31 and second free-surface film 32 so that anchoring force is extremely small.

In the present embodiment, first free-surface film 31 and second free-surface film 32 are each a film primarily made of SiOx. As an example, first free-surface film 31 and second free-surface film 32 are each a silicon oxide film made of silicon dioxide (SiO₂).

First free-surface film 31 and second free-surface film 32 each have a thickness ranging, for example, from 10 nm to 500 nm, but not necessarily. In the present embodiment, first free-surface film 31 and second free-surface film 32 each have a thickness of 100 nm.

First free-surface film 31 and second free-surface film 32 are each not limited to a film primarily made of SiOx and may each instead be a film primarily made of a metal, such as silver. For example, first free-surface film 31 and second free-surface film 32 may each be a metal film, such as a silver film made of silver. However, in the case where first free-surface film 31 and second free-surface film 32 are each a metal film, the metal film is preferably a very thin film having a film thickness of about several nanometers that allows light passes through first free-surface film 31 and second free-surface film 32.

### [Irregular Layer]

Irregular layer 40 is a layer having an irregular structure having an irregular surface and has a configuration in which a plurality of protrusions 41 on the order of micrometers or nanometers are arranged, as shown in FIG. 2. Irregular layer 40 is disposed on one of first electrode 21 and second electrode 22, which form a pair of electrodes. In the present embodiment, irregular layer 40 is so provided on second electrode 22 that the plurality of protrusions 41 protrude toward liquid crystal layer 50. In this case, an intimate contact layer may be formed between second electrode 22 and irregular layer 40. A surface of irregular layer 40 that is the surface facing second electrode 22 (surfaces of protrusions 41 that are surfaces facing second electrode 22) is a flat surface.

In the present embodiment, the plurality of protrusions 41 are formed in the form of stripes. Specifically, the plurality of protrusions 41 each have an elongated roughly quadrangular columnar shape having a trapezoidal cross-sectional shape and extending along the X axis and are arranged along the Z axis at equal intervals. All protrusions 41 have the same shape, but not necessarily.

Protrusions 41 each have a height, for example, greater than or equal to 100 nm but smaller than or equal to 100 μm and have an aspect ratio (height/bottom base) ranging from about 1 to 10, but not necessarily. As an example, protrusions 41 each have a height of about 10 μm, a lower base having a length of about 5 μm, and an upper base having a length of about 2 μm.

The distance between two adjacent protrusions 41 is, for example, greater than or equal to 0 mm but smaller than or equal to 100 mm. That is, two adjacent protrusions 41 may be so disposed as not to be in contact with each other but to be separate from each other by a predetermined distance or to be in contact with each other (with zero distance therebetween). The predetermined distance is preferably smaller than or equal to the length of the lower base of each of protrusions 41. As an example, in the case where protrusions 41 have the sizes described above (height: 10 μm, lower base: 5 μm, upper base 2 μm), the distance between two adjacent protrusions 41 is about 2 μm.

The plurality of protrusions 41 each have a pair of side surfaces. In the present embodiment, protrusions 41 each have tapered cross-sectional shape that tapers off along the direction from second base member 12 toward first base member 11 (negative direction of Y axis). Therefore, the pair of side surfaces of each of protrusions 41 are each an inclining surface that inclines with respect to the thickness by a predetermined inclination angle, and the distance between the pair of side surfaces (width of protrusion 41) gradually decreases with distance from second base member 12 toward first base member 11. The inclination angle between the two side surfaces of any of protrusions 41 may be equal to or differ from the inclination angle between the two side surfaces of other protrusions 41. In the present embodiment, the inclination angle between the two side surfaces of any of protrusions 41 is equal to the inclination angle between the two side surfaces of other protrusions 41.

At the upper one of the pair of side surfaces of each of protrusions 41, the light incident via second base member 12 on second free-surface film 32 passes through second free-surface film 32 with the light refracted or not refracted in accordance with the difference in refractive index between second free-surface film 32 and liquid crystal layer 50. Further, in the present embodiment, at the upper one of the pair of side surfaces of each of protrusions 41, part of the light incident via second base member 12 on second free-surface film 32 is totally reflected off the side surface depending on the angle of incidence of the light incident on the side surface. That is, second free-surface film 32 on the upper side surface of each of protrusions 41 can be a total reflection surface depending on the angle of incidence of the light incident on the side surface. Further, second free-surface film 32 desirably has a refractive index roughly equal to the refractive index of protrusions 41.

Irregular layer 40 (protrusions 41) can be made, for example, of a light-transmitting resin material, such as an acrylic resin, an epoxy resin, or a silicone resin. Irregular layer 40 can be formed, for example, by laser processing or imprinting. In the present embodiment, irregular layer 40 is made of an acrylic resin having a refractive index of 1.5.

Irregular layer 40 may be made only of an insulating resin material as long as first electrode 21 and second electrode 22 can impart an electric field to liquid crystal layer 50 or may be electrically conductive. In this case, irregular layer 40 can be made, for example, of an electrically conductive polymer, such as PEDOT, or a resin containing electrical conductors (electrical-conductor-containing resin).

### [Liquid Crystal Layer]

Liquid crystal layer 50 is located between first laminate substrate 10 and second laminate substrate 20. In the present embodiment, since irregular layer 40 is covered with second free-surface film 32, liquid crystal layer 50 is so provided between first free-surface film 31 and second free-surface film 32 that liquid crystal layer 50 are in contact both with first free-surface film 31 and second free-surface film 32.

Liquid crystal layer 50 functions as a refractive index adjusting layer capable of adjusting the refractive index primarily in the visible light region and the infrared region when an electric field is imparted to liquid crystal layer 50. Specifically, since liquid crystal layer 50 is made of a liquid crystal containing liquid crystal molecules 51 responsive to an electric field, the orientation of liquid crystal molecules 51 changes when an electric field is imparted to liquid crystal layer 50, and the refractive index of liquid crystal layer 50 changes accordingly.

An electric field is imparted to liquid crystal layer 50 when voltage is applied to first electrode 21 and second electrode 22. Controlling the voltage applied to first electrode 21 and second electrode 22 therefore changes the electric field imparted to liquid crystal layer 50, whereby the orientation of liquid crystal molecules 51 changes, and the refractive index of liquid crystal layer 50 changes accordingly. That is, the refractive index of liquid crystal layer 50 changes when voltage is applied to first electrode 21 and second electrode 22. In this case, an electric field may be imparted to liquid crystal layer 50 based on AC power or DC power. In the case of AC power, the voltage may have a sinusoidal waveform or a rectangular waveform.

In the present embodiment, liquid crystal layer 50 is made of a liquid crystal containing birefringent liquid crystal molecules 51 having ordinary light refractive index (n₀) and extraordinary light refractive index (nₑ). The liquid crystal can, for example, be nematic liquid crystal made of rod-shaped crystal molecules 51.

As an example, liquid crystal layer 50 is made of a positive liquid crystal containing rod-shaped liquid crystal molecules 51 each having a large dielectric constant along the major axis of the rod shape and a small dielectric constant along the axis perpendicular to the major axis (minor axis). Further, liquid crystal layer 50 preferably has a refractive index that changes between a refractive index close to the refractive index of second free-surface film 32 and a refractive index greatly different from the refractive index of second free-surface film 32. Therefore, in the present embodiment, since second free-surface film 32 has the refractive index of 1.5, the liquid crystal material of liquid crystal layer 50 is a positive nematic liquid crystal containing rod-shaped liquid crystal molecules 51 having an ordinary light refractive index of 1.5 and an extraordinary light refractive index of 1.7.

Liquid crystal layer 50 has a thickness (that is, gap between first laminate substrate 10 and second laminate substrate 20) ranging, for example, from 1 μm to 100 μm, but not necessarily. In the present embodiment, liquid crystal layer 50 has a thickness of 7 μm.

### [Method for Manufacturing Optical Device]

A method for manufacturing optical device 1 will next be described with reference to FIGS. 1 and 2.

First, a PET substrate is, for example, used as first base member 11 to form an ITO film as first electrode 21 on the PET substrate, and first free-surface film 31 is formed on the ITO film to produce first laminate substrate 10 (first laminate substrate producing step).

First free-surface film 31 is a silicon oxide film formed, for example, of SiO₂ and can be deposited by using evaporation, sputtering, or application. In the present embodiment, the ITO film is deposited as first electrode 21 on the PET substrate by using evaporation, and first electrode 21 (ITO film) and first free-surface film 31 can be successively deposited by depositing first free-surface film 31 in an evaporation process.

Thereafter, another PET substrate is, for example, used as second base member 12 to form second electrode 22 made of an ITO film on the PET substrate, and irregular layer 40 made of the plurality of protrusions 41 made of an acrylic resin (having refractive index of 1.5) is formed on the ITO film in an imprinting process to produce second laminate substrate 20 (second laminate substrate producing step).

In the present embodiment, after irregular layer 40 is formed, second free-surface film 32 is further so formed as to cover irregular layer 40 to produce second laminate substrate 20. Second free-surface film 32 can be deposited by using the same method as that used to form first free-surface film 31. In the present embodiment, second free-surface film 32 is deposited by using evaporation.

The gap between first laminate substrate 10 and second laminate substrate 20 is then filled with liquid crystal layer 50 (liquid crystal layer filling step).

In the present embodiment, in the liquid crystal filling step, first laminate substrate 10 and second laminate substrate 20 are so located that first free-surface film 31 and second free-surface film 32 face each other, and the gap between first laminate substrate 10 and second laminate substrate 20 is filled with liquid crystal layer 50.

Specifically, a positive nematic liquid crystal containing rod-shaped liquid crystal molecules 51 having the ordinary light refractive index of 1.5 and the extraordinary light refractive index of 1.7 is used as the liquid crystal material of liquid crystal layer 50 and injected into the gap between first laminate substrate 10 and second laminate substrate 20, and the outer circumferences of first laminate substrate 10 and second laminate substrate 20 are bonded to each other to encapsulate liquid crystal layer 50 between first laminate substrate 10 and second laminate substrate 20.

Optical device 1 having the structure shown in FIG. 1 can thus be manufactured.

### [Optical Effects of Optical Device]

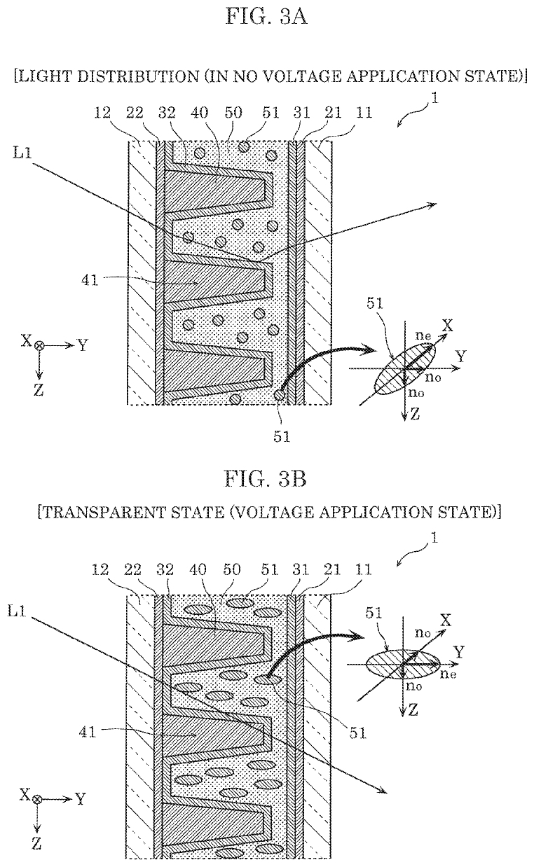

Optical effects of optical device 1 according to Embodiment 1 will next be described with reference to FIGS. 3A and 3B. FIG. 3A describes a first optical effect of optical device 1 according to Embodiment 1, and FIG. 3B describes a second optical effect of optical device 1 according to Embodiment 1.

Optical device 1 can be embodied as a window with a light distribution control function, for example, by installing optical device 1 in a window of a building. Optical device 1 is attached to a window of a building, for example, via an adhesive layer. In this case, optical device 1 is so disposed in the window that the longitudinal axis of protrusions 41 of irregular layer 40 coincides with the X axis. Sunlight, for example, is incident on optical device 1 installed in the window. In the present embodiment, since second base member 12 is the light-incident-side base member, optical device 1 allows the light (sunlight) incident through second base member 12 to pass through the interior of optical device 1 and exit out of optical device 1 via first base member 11.

In this process, the light incident on optical device 1 receives an optical effect from optical device 1 when the light passes through optical device 1. The optical effect of optical device 1 changes when the refractive index of liquid crystal layer 50, in accordance with which the incident light is refracted, changes. The light incident on optical device 1 therefore receives different optical effects in accordance with the refractive index of liquid crystal layer 50.

In the present embodiment, second free-surface film 32 is made of SiO₂ having the refractive index of 1.5, and liquid crystal layer 50 is made of a positive nematic liquid crystal having the ordinary light refractive index of 1.5 and the extraordinary light refractive index of 1.7, as described above.

Thus configured optical device 1, which operates in a first optical mode when no voltage is applied to first electrode 21 and second electrode 22 (in no voltage application state), as shown in FIG. 3A, imparts the first optical effect to the incident light.

In the first optical mode, in which first electrode 21 and second electrode 22 impart no electric field to liquid crystal layer 50, liquid crystal molecules 51 in liquid crystal layer 50 do not rotate but the attitude thereof is maintained, as shown in FIG. 3A. That is, the longitudinal axis of liquid crystal molecules 51 remains arranged along the longitudinal axis of protrusions 41.

In this case, when light L1 is obliquely incident on optical device 1, S-polarized light of S-polarized light and P-polarized light of light L1 senses the extraordinary refractive index (1.7) in liquid crystal layer 50, and a difference in refractive index between second free-surface film 32 and liquid crystal layer 50 is therefore created. On the other hand, the P-polarized light senses the ordinary refractive index (1.5), and no difference in refractive index between second free-surface film 32 and liquid crystal layer 50 is therefore created. In the present embodiment, since irregular layer 40 has the refractive index of 1.5, a difference of 0.2 in refractive index between second free-surface film 32 and liquid crystal layer 50 is created. Part of light L1 (S-polarized light) is totally reflected off the interface between liquid crystal layer 50 and second free-surface film 32 on the upper side surface of each of protrusions 41, travels in the direction in which the part of light L1 is deflected, and exits out of optical device 1. That is, the part of light L1 is distributed by optical device 1.

On the other hand, optical device 1, which operates in a second optical mode when voltage is applied to first electrode 21 and second electrode 22 (in voltage application state), imparts the second optical effect to the incident light.

In the second optical mode, in which first electrode 21 and second electrode 22 impart an electric field to liquid crystal layer 50, liquid crystal molecules 51 in liquid crystal layer 50 rotate in such a way that liquid crystal molecules 51 rise with respect to the principal surface of first base member 11 (second base member 12), as shown in FIG. 3B.

In this case, when light L1 is obliquely incident on optical device 1, both the S-polarized light and P-polarized light of light L1 sense the ordinary refractive index (1.5) in liquid crystal layer 50, and no difference in refractive index between second free-surface film 32 and liquid crystal layer 50 is therefore created. Light L1 (S-polarized light, P-polarized light) is therefore not refracted at the interface between liquid crystal layer 50 and second free-surface film 32 on the two upper and lower side surfaces of each of protrusions 41 and travels in the same direction. Therefore, in the second optical mode, the traveling direction of the light incident on optical device 1 is not deflected, but the light travels straight through optical device 1 and exits out thereof. That is, light L1 is not distributed by optical device 1 but passes straight therethrough.

As described above, optical device 1 is an active optical control device capable of changing the optical effect by controlling the relationship between the refractive index of second free-surface film 32 and the refractive index of liquid crystal layer 50 based on an electric field. That is, the operation mode of optical device 1 can be switched between the first optical mode (FIG. 3A) and the second optical mode (FIG. 3B) by controlling the voltage applied to first electrode 21 and second electrode 22.

In the first optical mode, light L1 is refracted at the interface where light L1 enters liquid crystal layer 50 from second free-surface film 32 and further refracted at the interface where light L1 exits out of liquid crystal layer 50 into first free-surface film 31. The angles of refraction change in accordance with the refractive index of liquid crystal layer 50, in accordance with which light L1 is refracted. That is, the exiting angle of light L1 changes in accordance with the voltage across first electrode 21 and second electrode 22 and can be variable by changing the voltage.

### [Advantageous Effects]

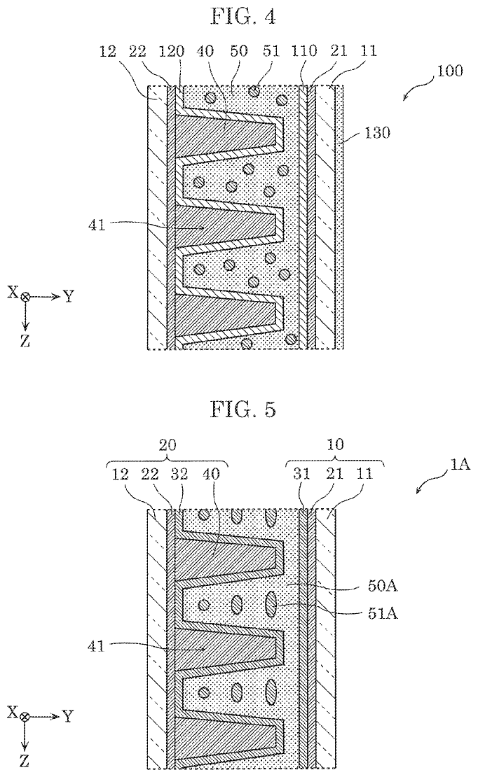

Advantageous effects of optical device 1 in the present embodiment, including a history of the present invention, will next be described with reference to FIG. 4. FIG. 4 is an enlarged cross-sectional view of optical device 100 according to Comparative Example.

An optical device in related art including a liquid crystal layer located between a pair of electrodes uses alignment films to provide desired optical characteristics by arranging the liquid crystal molecules in the liquid crystal layer along a fixed axis when no voltage is applied.

For example, as in optical device 100 according to Comparative Example shown in FIG. 4, it has been considered that first alignment film 110 is formed in the gap between first electrode 21 and liquid crystal layer 50. It has been further considered that second alignment film 120 is so formed in the gap between irregular layer 40 and liquid crystal layer 50 that second alignment film 120 faces first alignment film 110. To ensure a moisture-proof property of liquid crystal layer 50, barrier film 130 is attached onto the outer surface of first base member 11.

First alignment film 110 and second alignment film 120 are each typically a polyimide film. An orientation treatment in the form, for example, of a rubbing treatment or an UV light treatment is performed on first alignment film 110 and second alignment film 120. In this case, for example, alignment film 110 is formed on first base member 11 on which first electrode 21 has been formed, and alignment film 110 then undergoes the orientation treatment.

However, particularly in the method in which a rubbing treatment is performed on first alignment film 110 and second alignment film 120, foreign matter and other unwanted substances contaminate the alignment films during the rubbing treatment, resulting in a problem of a decrease in reliability of first alignment film 110 and second alignment film 120 because the orientation treatment does not work stably due to the contamination.

Further, the orientation treatment needs to be performed after an alignment film material (such as polyimide resin) is applied onto first base member 11 and second base member 12, resulting in an increase in the number of steps by one, leading to a problem of poor productivity. Moreover, to perform roll-to-roll manufacturing by using a resin base member, such as a PET film, the resin base member needs to be wound back after the orientation treatment, and the orientation performance deteriorates when the surface of the alignment film comes into contact with the rear surface of the PET film, resulting in deterioration of the orientation performance. It is therefore difficult to maintain the stability of the orientation of liquid crystal molecules 51 in liquid crystal layer 50, resulting in another problem of failure of maintenance of the quality of the liquid crystal layer over a long-term action. Further, since second alignment film 120 is formed on irregular layer 40, the orientation treatment is extremely difficult, resulting in extremely poor orientation stability.

As described above, an optical device using alignment films has problems of low reliability and poor productivity.

In view of the facts described above, the present inventors have intensively conducted studies and attained an idea of intentional use of no first alignment film 110 or second alignment film 120 but forming first free-surface film 31 and second free-surface film 32 in place of first alignment film 110 and second alignment film 120, as in optical device 1 shown in FIGS. 1 and 2. The present inventors have then actually produced and evaluated optical device 1.

As a result, it has been found that desired optical characteristics can be provided in the no voltage application state even with no use of first alignment film 110 or second alignment film 120. Specifically, the traveling direction of incident light can be changed, and the incident light can be output along the changed direction in the no voltage application state, as in optical device 1 shown in FIG. 3A. A consideration made by the present inventors on the above-mentioned point will be described below in detail.

According to the structure of optical device 1 shown in FIGS. 1 and 2, in which first free-surface film 31 and second free-surface film 32 are in contact with liquid crystal layer 50, liquid crystal molecules 51 present in the vicinity of the interface between liquid crystal layer 50 and first free-surface film 31 and between liquid crystal layer 50 and second free-surface film 32 hardly receive an effect based on intermolecular force from first free-surface film 31, resulting in a low free energy state. That is, light distribution restriction force (anchoring force) at the interfaces of liquid crystal layer 50 can be greatly lowered, as compared with the case where alignment film 110 is provided.

As a result, liquid crystal molecules 51 in liquid crystal layer 50 are oriented dominantly by the effect of the irregular structure of irregular layer 40 and the effect of liquid crystal molecules 51 themselves. Specifically, since liquid crystal layer 50 has an irregular shape resulting from the plurality of protrusions 41 formed in the form of stripes, liquid crystal molecules 51, which are rod-shaped molecules, are so oriented that the longitudinal axis of liquid crystal molecules 51 coincides with the longitudinal axis of the gap (that is, recess) between two adjacent protrusions 41, as shown in FIG. 2. It is believed that the effect described above allows desired distribution of the incident light in the no voltage application state, as shown in FIG. 3A.

As described above, optical device 1 in the present embodiment, which can provide desired optical characteristics in no voltage application state even with use of no alignment film, can suppress a decrease in reliability and poor productivity, unlike an optical device using alignment films.

Further, optical device 1 in the present embodiment, which uses first free-surface film 31 and second free-surface film 32 in place of alignment films, can also advantageously move liquid crystal molecules 51 in liquid crystal layer 50 at low voltage.

That is, to move liquid crystal molecules 51 oriented by first alignment film 110 and second alignment film 120, as in optical device 100 according to Comparative Example shown in FIG. 4, drive voltage having a fixed value or greater is required. On the other hand, in optical device 1 in the present embodiment, which uses first free-surface film 31 and second free-surface film 32 in place of first alignment film 110 and second alignment film 120, liquid crystal molecules 51 in the vicinity of the interfaces of liquid crystal layer 50 receive low anchoring force, having the orientation not being restricted by alignment film 110

As a result, liquid crystal molecules 51 can be readily moved even at low drive voltage. That is, optical device 1 in the present embodiment can drive liquid crystal layer 50 at low voltage as compared with optical device 100 in Comparative Example. Optical device 1 can therefore save electric power.

As described above, according to optical device 1 in the present embodiment, an active optical device that excels in productivity and reliability and allows power saving can be achieved, as compared with optical device 100 in Comparative Example.

Further, in optical device 100 in Comparative Example shown in FIG. 4, barrier film 130 is provided on the outer surface of first base member 11, which is the surface opposite the surface attached to window glass in order to ensure the moisture-proof property of liquid crystal layer 50, whereas in the present embodiment, first free-surface film 31, which is primarily made of SiOx, is disposed on a side of liquid crystal layer 50 that is the side facing first base member 11, whereby first free-surface film 31 can ensure the moisture-proof property of liquid crystal layer 50 with no barrier film 130 on first base member 11. That is, disposing first free-surface film 31 at first base member 11 can also provide the effect of omitting barrier film 130 provided on first base member 11.

Further, in optical device 1 in the present embodiment, first free-surface film 31 and second free-surface film 32 sandwich liquid crystal layer 50 in such a way that the opposite interfaces of liquid crystal layer 50 are both in contact with the free-surface films.

As a result, liquid crystal molecules 51 present in the vicinity of the opposite interfaces of liquid crystal layer 50 each have low free energy, so that liquid crystal molecules 51 in entire liquid crystal layer 60 are more likely to receive the influence of the irregular structure of irregular layer 40 and the effect of liquid crystal molecules 51 themselves. Liquid crystal molecules 51 are therefore likely to be oriented with one another along the longitudinal axis of protrusions 41 in the case where both first free-surface film 31 and second free-surface film 32 are disposed as compared with a case where only first free-surface film 31 is disposed. That is, variation in the orientation of liquid crystal molecules 51 can be suppressed across the entire area of liquid crystal layer 50. Unevenness of light distribution in the no voltage application state can therefore be suppressed.

Using optical device 1, in which both first free-surface film 31 and second free-surface film 32 are disposed, allows further improvement in the optical characteristics in the no voltage application state.

### Embodiment 2

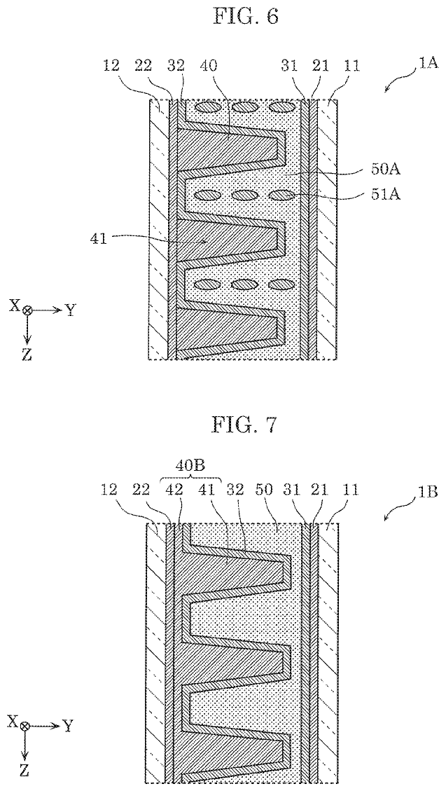

Optical device 1A according to Embodiment 2 will next be described with reference to FIGS. 5 and 6. FIG. 5 is an enlarged cross-sectional view of optical device 1A according to Embodiment 2. FIG. 6 shows the arrangement of liquid crystal molecules 51A in a case where voltage is applied to optical device 1A according to Embodiment 2.

Optical device 1A in the present embodiment differs from optical device 1 in Embodiment 1 described above in terms of the liquid crystal material of the liquid crystal layer. Specifically, in optical device 1A in the present embodiment, liquid crystal layer 50A is made of a liquid crystal to which a chiral material is added (chiral liquid crystal).

More specifically, in the present embodiment, a positive nematic liquid crystal containing rod-shaped liquid crystal molecules 51A having the ordinary light refractive index of 1.5 and the extraordinary light refractive index of 1.7 is used as base liquid crystal, and the nematic liquid crystal to which a chiral material is added is used as the liquid crystal material of liquid crystal layer 50A.

That is, in the present embodiment, the liquid crystal material of liquid crystal layer 50 in Embodiment 1 to which a chiral material is added is used. The chiral material may be introduced in advance into the base liquid crystal of liquid crystal layer 50A before the gap between first laminate substrate 10 and second laminate substrate 20 is filled with the base liquid crystal.

Using liquid crystal to which a chiral material is added as the liquid crystal material of liquid crystal layer 50A as described above allows liquid crystal molecules 51A in liquid crystal layer 50A to have a spontaneous twist, as shown in FIG. 5, whereby elastic constant (K2) of liquid crystal layer 50A can be increased.

Liquid crystal molecules 51A in liquid crystal layer 50A sandwiched between first free-surface film 31 and second free-surface film 32 are therefore oriented by the effect of the irregular structure of irregular layer 40 and the effect of liquid crystal molecules 51 themselves, as in Embodiment, 1. In the present embodiment, however, liquid crystal molecules 51A has spontaneous twist, whereby liquid crystal molecules 51A receives the effect of the elastic force produced by liquid crystal molecules 51A themselves by a greater degree. Specifically, the orientation of liquid crystal molecules 51A in liquid crystal layer 50A in the present embodiment is restricted by the elastic force of liquid crystal layer 50A produced by liquid crystal molecules 51A themselves.

As a result, liquid crystal molecules 51A are restricted as if a spring extends by each of the grooves of the irregular structure of irregular layer 40 and are so oriented as to be twisted by a fixed angle in the direction from second base member 12 toward first base member 11, as shown in FIG. 5. Liquid crystal molecules 51A separate from the interfaces of liquid crystal layer 50A can therefore also be oriented. As a result, variation in the orientation of liquid crystal molecules 51A can be eliminated across the entire area of liquid crystal layer 50A, whereby unevenness of light distribution in the no voltage application state can be eliminated.

That is, in optical device 1 in Embodiment 1 described above, part of liquid crystal layer 50 is an area where liquid crystal molecules 51 are oriented differently (disclination), possibly resulting in unevenness of light distribution in the no voltage application state.

In contrast, in optical device 1A in the present embodiment, in which liquid crystal molecules 51A are so oriented as to be twisted is a fixed manner across the entire area of liquid crystal layer 50A, the disclination can be suppressed. Unevenness of light distribution in the no voltage application state can thus be suppressed as compared with optical device 1 in Embodiment 1 described above. That is, the light distribution factor can be improved.

In the voltage application state, liquid crystal molecules 51A in liquid crystal layer 50A rotate in such a way that liquid crystal molecules 51A rise with respect to the principal surface of first base member 11 (second base member 12), and liquid crystal molecules 51A has no twist, as shown in FIG. 6. In this case, the traveling direction of light (such as sunlight) obliquely incident on optical device 1A is not deflected, but the light travels straight through optical device 1A and passes therethrough as in the case of optical device 1 in Embodiment 1.

As described above, optical device 1A in the present embodiment, which includes first free-surface film 31 and second free-surface film 32, as does optical device 1 in Embodiment 1 described above, provides the same effects as those provided by optical device 1 in Embodiment 1 described above. That is, according to optical device 1A in the present embodiment, an active optical device that excels in productivity and reliability and allows power saving can be achieved. Further, the moisture-proof property of liquid crystal layer 50A can be ensured with no barrier film.

Moreover, optical device 1A in the present embodiment uses a liquid crystal to which a chiral material is added as the liquid crystal material of liquid crystal layer 50A.

Unevenness of light distribution in the voltage application state can thus be suppressed as compared with optical device 1 in Embodiment 1 described above.

In the present embodiment, the elastic constant (K2) of liquid crystal layer 50A is increased by the spontaneous twist resulting from addition of a chiral to the base liquid crystal, but not necessarily. For example, in consideration of the fact that the elastic constant of a liquid crystal material is classified into elastic constant k1, which relates to spray (spread) deformation, elastic constant k2, which relates to twist deformation, and elastic constant k3, which relates to bending deformation, liquid crystal having large elastic constant k2 may be used as the liquid crystal material itself of liquid crystal layer 50A instead of adding a chiral material to the base liquid crystal. Also in this case, unevenness of light distribution in the no voltage application state can be suppressed. Further, as the liquid crystal material of liquid crystal layer 50A, a liquid crystal having large elastic constant k2 may be used as the base liquid crystal, and a chiral material may further be added thereto. In this case, unevenness of light distribution in the no voltage application state can be further suppressed.

### (Variation 1)

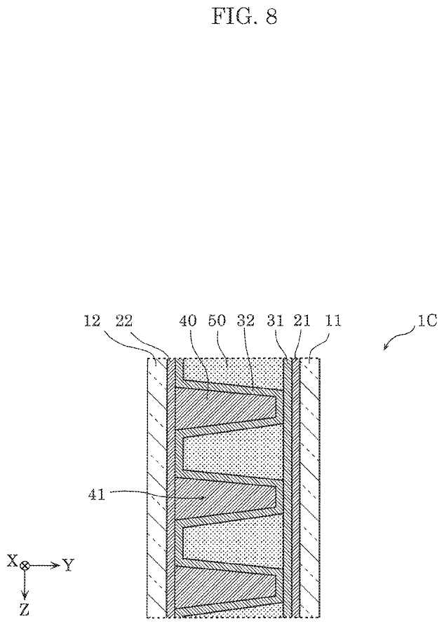

Optical device 1B according to Variation 1 will next be described with reference to FIG. 7. FIG. 7 is an enlarged cross-sectional view of optical device 1B according to Variation 1. In FIG. 7, the liquid crystal molecules in liquid crystal layer 50 are omitted.

In optical device 1 in Embodiment 1 described above, the plurality of protrusions 41 of irregular layer 40 are so formed as to be separated from each other, whereas in optical device 1B in the present variation, a plurality of protrusions 41 of irregular layer 40B are linked to each other, as shown in FIG. 7.

Specifically, irregular layer 40B is made of thin film layer 42, which is formed on first base member 11 side, and a plurality of protrusions 41, which protrude from thin film layer 42. Thin film layer 42 may be intentionally formed or may be formed as a residual film when the plurality of protrusions 41 are formed.

As described above, optical device LB in the present variation also provides the same effects as those provided by optical device 1 in Embodiment 1 described above. The present variation is also applicable to optical device 1A in Embodiment 2 described above.

### (Variation 2)

Optical device 1C according to Variation 2 will next be described with reference to FIG. 8. FIG. 8 is an enlarged cross-sectional view of optical device 1C according to Variation 2. In FIG. 8, the liquid crystal molecules in liquid crystal layer 50 are omitted.

In optical device 1 in Embodiment 1 described above, liquid crystal layer 50 is present between protrusions 41 of irregular layer 40 and first free-surface film 31, whereas in optical device 1C in the present variation, no liquid crystal layer 50 is present between protrusions 41 of irregular layer 40 and first free-surface film 31, as shown in FIG. 8. Specifically, second free-surface film 32 formed on the surfaces of protrusions 41 is in contact with first free-surface film 31, and liquid crystal layer 50 is divided into a plurality of liquid crystal layers 50 by the plurality of protrusions 41 of irregular layer 40.

There is therefore no unnecessary optical effect resulting from liquid crystal layer 50 between protrusions 41 and first free-surface film 31. Specifically, light L1 is not scattered, and a degree of cloudiness (haze) that serves as an indicator of transparency decreases, whereby clearer transparency can be provided.

As described above, optical device 1C in the present variation also provides the same effects as those provided by optical device 1 in Embodiment 1 described above. The present variation is also applicable to optical device 1A in Embodiment 2 described above. The transparency can also be improved.

### (Other Variations and the Like)

Optical devices according to the present invention have been described above based on the embodiments and variations, but the present invention is not limited to the embodiments and variations described above.

For example, in Embodiments 1 and 2 and Variations 1 and 2 described above, protrusions 41, which form irregular layers 40 and 40B, each have an elongated roughly quadrangular columnar shape having a roughly trapezoidal cross-sectional shape, but not necessarily. Protrusions 41 may each instead have, for example, an elongated roughly triangular columnar shape having a roughly triangular cross-sectional shape. Further, the side surface sections of the cross-sectional shape may have curved or sawtooth edges. Moreover, protrusions 41 may not be arranged in the form of stripes but may be arranged in the form of dots.

In Embodiments 1 and 2 and Variations 1 and 2 described above, the plurality of protrusions 41 have the same shape, but not necessarily, and may have, for example, different in-plane shapes. For example, the side surfaces (inclining surfaces) of the plurality of protrusions 41 may be different in inclination angle between the upper and lower halves of optical device 1 along the Z axis.

In Embodiments 1 and 2 and Variations 1 and 2 described above, the plurality of protrusions 41 have a fixed height, but not necessarily. For example, the plurality of protrusions 41 may randomly differ from one another in terms of height. Still instead, the interval between protrusions 41 may randomly differ from one another, and both the height and interval may randomly differ from one another. The randomly set height and/or interval can prevent light passing through the optical device from being viewed as iridescent light. That is, randomly differentiating the heights of the plurality of protrusions 41 from one another averages a small amount of light diffracted and scattered at the irregular interface between irregular layer 40 or 40B and liquid crystal layer 50 over the wavelength to suppress coloring of the exiting light.

In Embodiments 1 and 2 and Variations 1 and 2 described above, irregular layers 40 and 40B may be formed both at first base member 11 and second base member 12. In this case, a first irregular layer having a first irregular structure may be formed between first electrode 21 and first free-surface film 31, and a second irregular layer having a second irregular structure may be formed between second electrode 22 and second free-surface film 32.

In Embodiments 1 and 2 and Variations 1 and 2 described above, at least one of first electrode 21 and second electrode 22 may be an electrode divided into stripes.

In Embodiments 1 and 2 and Variations 1 and 2 described above, irregular layers 40 and 40B themselves may each be a free-surface film made, for example, of SiO₂. That is, irregular layers 40 and 40B may be integrated with first free-surface film 31. In the case where the first irregular layer is formed between first electrode 21 and first free-surface film 31 and the second irregular layer is formed between second electrode 22 and second free-surface film 32, the first irregular layer may be integrated with first free-surface film 31, and the second irregular layer may be integrated with second free-surface film 32.

In Embodiments 1 and 2 and Variations 1 and 2 described above, the liquid crystal material of liquid crystal layers 50 and 50A is not limited to a nematic liquid crystal having positive dielectric anisotropy and may instead, for example, be a nematic liquid crystal having negative dielectric anisotropy.

In each of Embodiment 1 and others described above, light incident on the optical device is sunlight by way of example, but not necessarily. For example, light incident on optical device 1 may be light emitted from a light emitting apparatus, such as a lighting tool.

In each of Embodiment 1 and others described above, the optical device is so disposed in a window that the longitudinal axis of protrusions 41 coincides with the X axis, but not necessarily. For example, the optical device may be so disposed in a window that the longitudinal axis of protrusions 41 coincides with the Z axis.

In each of Embodiment 1 and others described above, the optical device is attached to a window. The optical device may instead be used as the window itself of a building. Further, the optical device is not necessarily installed in a window of a building and may instead be installed, for example, in a window of a car.

Furthermore, various modifications of the embodiments and variations which those skilled in the art can conceive or desirable combinations of the structural elements and functions in the embodiments and variations without materially departing from the present invention are also included in the present invention.

### REFERENCE MARKS IN THE DRAWINGS

1, 1A, 1B, 1C optical device
11 first base member
12 second base member
21 first electrode
22 second electrode
31 first free-surface film
32 second free-surface film
40, 40B irregular layer
50, 50A liquid crystal layer

1. An optical device, comprising:
a pair of base members having a light transmittance;
a pair of electrodes having a light transmittance and located between the pair of base members;
a first free-surface film comprising an inorganic material and disposed above one of the pair of electrodes;
a second free-surface film comprising an inorganic material and disposed above another of the pair of electrodes; and
a liquid crystal layer located between the first free-surface film and the second free-surface film.

2. The optical device according to claim 1, further comprising:
a first irregular layer having a first irregular structure and located between the one of the pair of electrodes and the first free-surface film.

3. The optical device according to claim 2, further comprising:
a second irregular layer having a second irregular structure and located between the other of the pair of electrodes and the second free-surface film.

4. The optical device according to claim 2,
wherein the first irregular layer is integrated with the first free-surface film.

5. The optical device according to claim 3,
wherein the second irregular layer is integrated with the second free-surface film.

6. The optical device according to claim 1,
wherein the liquid crystal layer comprises a liquid crystal to which a chiral material is added.

7. The optical device according to claim 1,
wherein at least one of the first free-surface film and the second free-surface film is a film primarily comprising SiOx.

8. The optical device according to claim 1,
wherein the liquid crystal layer comprises a positive liquid crystal.

9. A method for manufacturing an optical device, the method comprising:
forming a first electrode having a light transmittance on a first base member having a light transmittance and forming a first free-surface film comprising an inorganic material on the first electrode, thereby producing a first laminate substrate;
forming a second electrode having a light transmittance on a second base member having a light transmittance and forming a second free-surface film comprising an inorganic material on the second electrode, thereby producing a second laminate substrate; and
disposing the first laminate substrate and the second laminate substrate in such a way that the first free-surface film and the second free-surface film face each other, and filling a gap between the first laminate substrate and the second laminate substrate with a liquid crystal layer,
wherein in the producing of the first laminate substrate, at least one of the first free-surface film and the second free-surface film is deposited by using evaporation, sputtering, or application.

10. The method according to claim 9,
wherein the first laminate substrate is produced by forming a first irregular layer on the first electrode.

11. The method according to claim 10,
wherein the second laminate substrate is produced by forming a second irregular layer on the second electrode.

12. The method according to claim 9,
wherein at least one of the first free-surface film and the second free-surface film is a film primarily comprising SiOx.
